(19) United States
(12) Patent Application Publication
(10) Pub. No.: US 2026/0323186 A1
(43) Pub. Date: Oct. 15, 2026

(54) PHOTOELECTRIC CONVERSION DEVICE, EQUIPMENT, AND PROCESSING DEVICE

(71) Applicant: CANON KABUSHIKI KAISHA, Tokyo (JP)

(72) Inventor: MAASA ITO, Tokyo (JP)

(21) Appl. No.: 19/463,933

(22) Filed: Jan. 29, 2026

(30) Foreign Application Priority Data
Feb. 6, 2025 (JP) 2025-018548

(51) Int. Cl. H04N 25/773

(52) U.S. Cl. CPC H04N 25/773

(57) ABSTRACT

A device includes: a plurality of pixels; an output circuit configured to output subframes based on outputs of the plurality of pixels; and a processing circuit configured to generate one frame from a plurality of subframes output from the output circuit. For each pixel of the plurality of pixels, the processing circuit is configured to acquire an effective value corresponding to a subframe where light was detected out of the plurality of subframes, and is configured to generate a weighting coefficient of each pixel based on a magnitude of the effective value of each of the plurality of pixels, and the processing circuit has a driving mode for generating a pixel value of each pixel in the frame based on the weighting coefficient.

### BACKGROUND

### Field of the Technology

The aspect of the embodiments relates to a photoelectric conversion device, equipment, and a processing device.

### Description of the Related Art

As a light detection device that can detect weak light of a single photon level using avalanche (electron avalanche) multiplication, a Single Photon Avalanche Diode (SPAD) is known. Japanese Patent Laid-Open No. 2021-044636 describes a photoelectric conversion device that includes a pixel including an avalanche photodiode (APD) functioning as an SPAD.

In image capturing in a dark environment, the number of incident photons decreases. Therefore, in a given pixel, a plurality of subframes constituting one frame for generating one image include subframes where photons were detected and subframes where photons were not detected. In this case, even when capturing the same object, the number of subframes where photons were detected changes between frames, and the obtained video may appear grainy.

### SUMMARY

According to some embodiments, a device comprising: a plurality of pixels; an output circuit configured to output subframes based on outputs of the plurality of pixels; and a processing circuit configured to generate one frame from a plurality of subframes output from the output circuit, wherein for each pixel of the plurality of pixels, the processing circuit is configured to acquire an effective value corresponding to a subframe where light was detected out of the plurality of subframes, and is configured to generate a weighting coefficient of each pixel based on a magnitude of the effective value of each of the plurality of pixels, and the processing circuit has a driving mode for generating a pixel value of each pixel in the frame based on the weighting coefficient, is provided..

Features of the disclosure will become apparent from the following description of embodiments with reference to the attached drawings. The following description of embodiments is described by way of example.

### BRIEF DESCRIPTION OF THE DRAWINGS

FIG. 1 is a view showing an example of the configuration of a photoelectric conversion device according to an embodiment;

FIG. 2 is a block diagram showing an example of the configuration of a pixel of the photoelectric conversion device shown in FIG. 1;

FIGS. 3A and 3B are views showing an example of the operation of the photoelectric conversion device shown in FIG. 1;

FIG. 4 is a view showing an example of the configuration of the photoelectric conversion device shown in FIG. 1; and

FIG. 5 is a view showing an example of the configuration of equipment incorporating the photoelectric conversion device according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

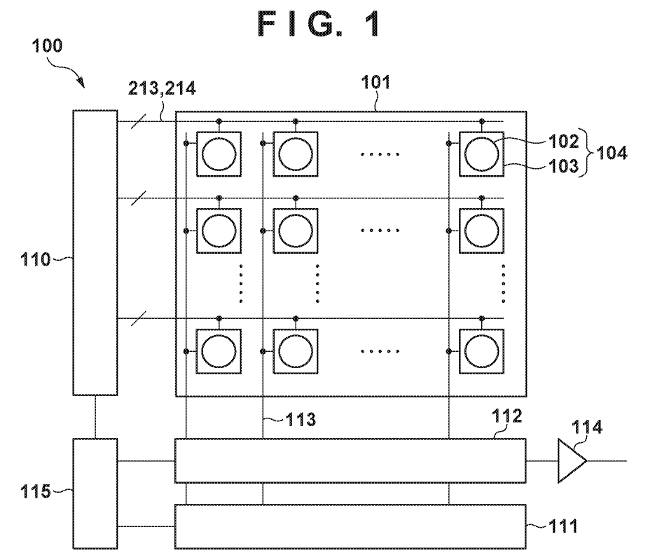

With reference to FIGS. 1-4, a photoelectric conversion device according to an embodiment of the disclosure will be described. First, with reference to FIG. 1, a photoelectric conversion device applicable to the embodiment of the disclosure will be described based on a general SPAD operation. FIG. 1 is a block diagram showing an example of the configuration of a photoelectric conversion device 100 according to this embodiment. The photoelectric conversion device 100 includes a pixel array 101, a control pulse generation circuit 115, a horizontal scanning circuit 111, a readout circuit 112, a vertical scanning circuit 110, signal lines 113, and driving lines 213 and 214. A plurality of pixels 104 are arranged in a matrix in the pixel array 101. Each pixel 104 can be formed by including a photoelectric conversion unit 102 including an avalanche photodiode (APD) and a signal processing circuit 103. The photoelectric conversion unit 102 converts light into an electrical signal. The signal processing circuit 103 outputs the converted electrical signal to the readout circuit 112.

The vertical scanning circuit 110 receives a control pulse supplied from the control pulse generation circuit 115, and supplies a control pulse to the pixel 104. A logic circuit such as a shift register or an address decoder can be used for the vertical scanning circuit 110.

A signal output from the photoelectric conversion unit 102 of each pixel 104 is processed by the signal processing circuit 103. The signal processing circuit 103 is provided with, for example, a counter, a memory, and the like, and the memory holds a digital value.

In order to read out a signal from the memory holding the digital signal of the pixel 104, the horizontal scanning circuit 111 inputs, to the signal processing circuit 103, a control pulse for sequentially selecting respective columns. As for a selected column, a signal is output to the signal line 113 from the signal processing circuit 103 of the pixel selected by the vertical scanning circuit 110. The signal output to the signal line 113 is output via the readout circuit 112 and an output circuit 114 to a recording circuit or a processing circuit arranged in the photoelectric conversion device 100, a recording device or a processing device arranged outside the photoelectric conversion device 100, or the like.

In the configuration shown in FIG. 1, the pixels 104 are arranged two-dimensionally in the pixel array 101. However, the disclosure is not limited to this, and the pixels 104 may be arranged one-dimensionally in the pixel array 101. The function of the signal processing circuit 103 is not necessarily provided to individually correspond to each of all the pixels 104. For example, one signal processing circuit 103 may be shared by the plurality of pixels 104 to sequentially perform signal processing.

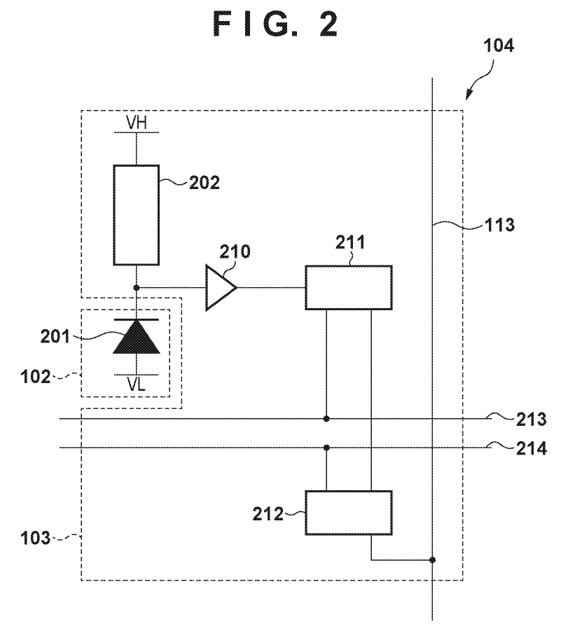

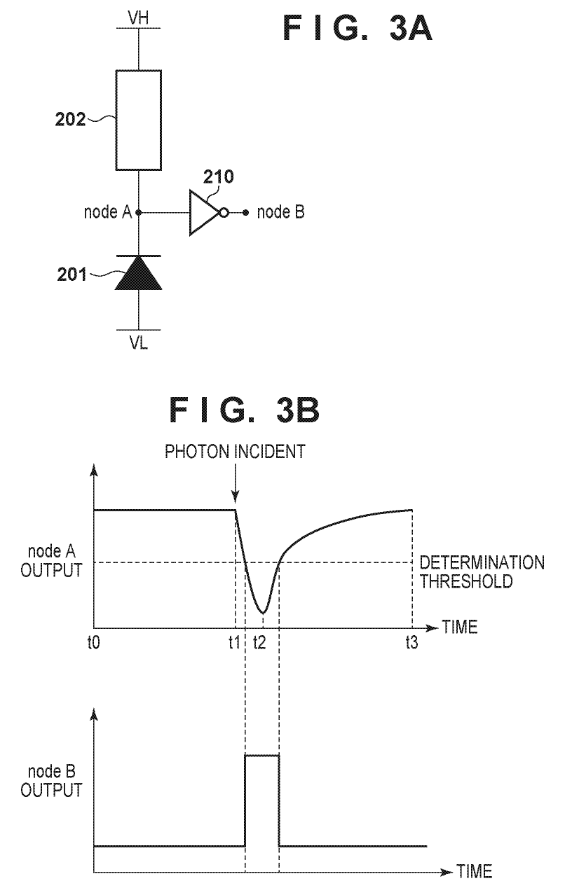

FIG. 2 is a block diagram showing an example of the configuration of one pixel 104 shown in FIG. 1. With reference to FIG. 2 and FIGS. 3A and 3B to be described later, the basic configuration and operation of the pixel 104 including an APD will be described.

As shown in FIG. 2, an APD 201 is arranged in the photoelectric conversion unit 102 of the pixel 104. The APD 201 generates a charge pair corresponding to incident light by photoelectric conversion. A potential VL is supplied to the anode of the APD 201. A potential VH higher than the potential VL supplied to the anode is supplied to the cathode of the APD 201. Thus, a reverse bias voltage is supplied between the anode and the cathode, which causes an avalanche multiplication operation of the APD 201. By setting a state in which such the voltage is supplied, charges generated by incident light undergo avalanche multiplication and an avalanche current is generated. In the following description, for simplicity, VL = -Vbd, and VH = Vex. Here, Vbd is the breakdown voltage of the APD 201, and Vex is an excess voltage. Normally, VL is about -20 V to -30 V, and VH is about 2 V to 3 V.

As shown in FIG. 2, the signal processing circuit 103 of the pixel 104 can include a quench element 202, a waveform shaping circuit 210, a counter circuit 211, and a selection circuit 212. However, the disclosure is not limited to this, and the signal processing circuit 103 may include another circuit related to signal processing.

The quench element 202 is connected to a supply line for supplying the potential VH and the APD 201. The quench element 202 has a function of converting a change in avalanche current generated in the APD 201 into a voltage signal. The quench element 202 functions as a load circuit (quench circuit) at the time of signal multiplication by avalanche multiplication, and operates to suppress the voltage supplied to the APD 201, thereby suppressing avalanche multiplication (quench operation).

The waveform shaping circuit 210 shapes the potential change of the cathode of the APD 201 that is obtained at the time of photon detection, and outputs a pulse signal. Consequently, the waveform shaping circuit 210 functions as a detection circuit that detects avalanche breakdown occurring in the APD 201. As the waveform shaping circuit 210, for example, an inverter circuit may be used. In the configuration shown in FIG. 2, a configuration example including one inverter as the waveform shaping circuit 210 is shown. However, the disclosure is not limited to this, and a circuit constituted by series-connecting a plurality of inverters may be used as the waveform shaping circuit 210. Alternatively, another circuit having the waveform shaping effect may be used as the waveform shaping circuit 210.

The counter circuit 211 counts the number of pulse signals output from the waveform shaping circuit 210 and holds the count value. When a control pulse pRES is supplied to the counter circuit 211 from the vertical scanning circuit 110 shown in FIG. 1 via a driving line 213, the value held by the counter circuit 211 is reset.

The selection circuit 212 is supplied with a control pulse pSEL from the vertical scanning circuit 110 shown in FIG. 1 via a driving line 214, and switches electrical connection/disconnection between the counter circuit 211 and the signal line 113. The selection circuit 212 can be formed by including, for example, a buffer circuit for outputting a signal.

A switching element such as a transistor may be arranged between the quench element 202 and the APD 201 or between the photoelectric conversion unit 102 and the signal processing circuit 103 to switch electrical connection. Similarly, supply of the potential VH or potential VL to the photoelectric conversion unit 102 may be electrically switched using a switching element such as a transistor.

FIG. 2 shows the configuration where the counter circuit 211 is used in the signal processing circuit 103. However, the disclosure is not limited to this. A Time-to-Digital Converter (TDC) and a memory may be used instead of the counter circuit 211 to configure the photoelectric conversion device 100 that acquires the detection timing of the pulse signal output from the waveform shaping circuit 210. In this case, the generation timing of a pulse signal output from the waveform shaping circuit 210 is converted into a digital signal by the TDC. The TDC is supplied with a control pulse pREF from the vertical scanning circuit 110 via a driving line (which can be similar to the driving lines 213 and 214) for measurement of the output timing of the pulse signal. The TDC acquires, as a digital signal, a signal which expresses the input timing of a signal output from the pixel 104 via the waveform shaping circuit 210 as the relative time with the control pulse pREF as a reference.

FIGS. 3A and 3B are views schematically showing the relationship between the operation of the APD 201 and an output signal. FIG. 3A is a view showing an excerpt of the APD 201, quench element 202, and waveform shaping circuit 210 shown in FIG. 2. Here, the input side of the waveform shaping circuit 210 is a node A and its output side is a node B. FIG. 3B shows potential changes at the node A and the node B.

From time t0 to time t1, a potential difference (voltage) of the potential VH - the potential VL is applied to the APD 201. When a photon enters the APD 201 at time t1, avalanche breakdown occurs in the APD 201, an avalanche multiplication current flows to the quench element 202, and the potential of the node A drops. When the potential drop amount further increases and the potential difference applied to the APD 201 decreases, the avalanche breakdown in the APD 201 stops as shown at time t2, and the potential level of the node A does not drop any more from a predetermined value. The potential at which the avalanche breakdown stops is about 0 V, that is, the potential at which the voltage applied to the APD 201 becomes about Vbd. After that, during a period from time t2 to time t3, a current compensating for the potential drop from the potential VL flows to the node A, and the node A is settled at the original potential level at time t3. At this time, a portion of the output waveform of node A, which exceeds a given threshold, is shaped by the waveform shaping circuit 210, and output as a signal to the node B.

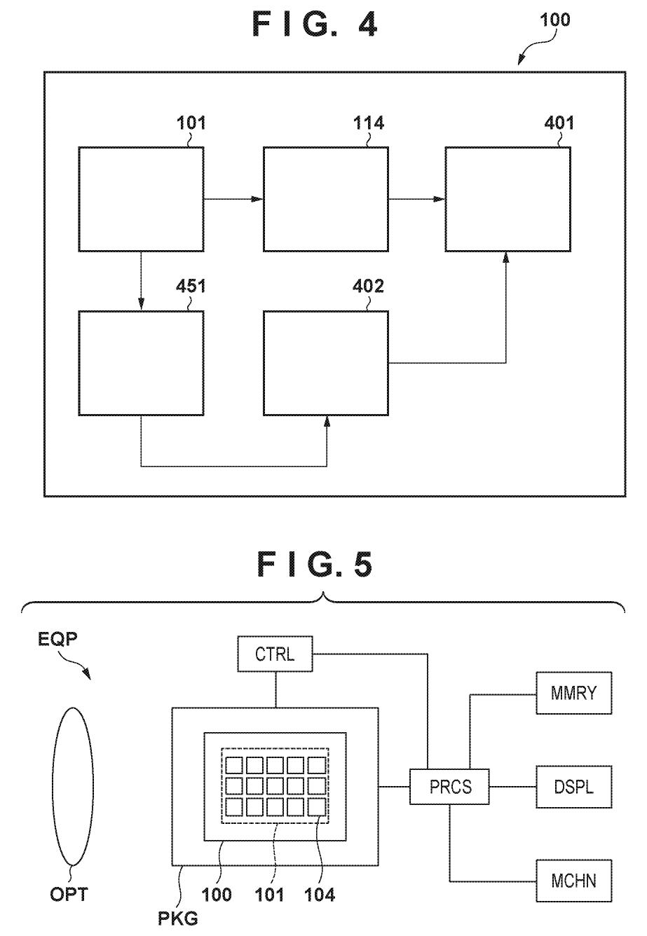

FIG. 4 is a block diagram showing an example of the configuration for implementing signal processing in the photoelectric conversion device 100 according to this embodiment. The process described below assumes a case where the photoelectric conversion device 100 according to this embodiment functions as an SPAD to detect weak light. One frame generating one image is constituted by a plurality of subframes. Under an extremely dark environment, in each pixel 104, there can be a subframe where light (photon) is detected and a subframe where light is not detected. Therefore, the number of subframes where light was detected changes between frames, and the obtained video may appear grainy (noisy). It is conceivable to suppress the variation in the number of light detections between frames by increasing the number of subframes constituting one frame, but this lowers the frame rate. The process described in this embodiment can improve the quality of the obtained image without lowering the frame rate.

The photoelectric conversion device 100 shown in FIG. 4 includes, in addition to the components shown in FIG. 1, a processing circuit 401, and a control circuit 402 configured to control the operation of each component in the photoelectric conversion device 100. In addition, as will be described later, the photoelectric conversion device 100 can include a sensor 451. FIG. 4 shows the pixel array 101 and the output circuit 114 shown in FIG. 1. To focus on signal processing in the photoelectric conversion device 100, illustration of the vertical scanning circuit 110, the horizontal scanning circuit 111, the readout circuit 112, the control pulse generation circuit 115, and the like are omitted.

When an avalanche multiplication current flows as described above in accordance with incident light (photon), the pixel 104 arranged in the pixel array 101 outputs a detection signal. The detection signal is a signal indicating that light entered the pixel 104. The output of each pixel 104 is supplied to the output circuit 114 via the readout circuit 112.

Based on the output of each of the plurality of pixels 104, the output circuit 114 outputs a subframe. One subframe can include information indicating whether light was detected in one subframe period in each pixel 104. The information of each pixel 104 in each subframe can be, for example, 1-bit information including "1" indicating that light entered and the pixel 104 has output the detection signal, or "0" indicating that light was not detected. The subframe output from the output circuit 114 is supplied to the processing circuit 401.

The processing circuit 401 generates one frame from the plurality of subframes output from the output circuit 114. First, for each pixel of the plurality of pixels 104, the processing circuit 401 acquires an effective value corresponding to the subframe where light was detected out of the plurality of subframes. Then, based on the magnitude of the effective value of each of the plurality of pixels 104, the processing circuit 401 generates a weighting coefficient of each pixel 104. Here, the effective value corresponding to the subframe where light was detected can indicate, for example, the number of subframes where light was detected out of the plurality of subframes in the pixel 104. After the weighting coefficient is generated, the processing circuit 401 generates the pixel value of each pixel 104 in the frame based on the weighting coefficient of the pixel.

For example, consider a case where, for N subframes constituting one frame, a pixel A detects light (the detection signal is recorded) in h subframes, a pixel B detects light (the detection signal is recorded) in k subframes, and k is larger than h (h < k). In this case, the processing circuit 401 first applies a gain to each of the effective values h and k of the pixels A and B, which indicates the number of subframes where light was detected, thereby setting a reference value. It can also be said that the processing circuit 401 sets the pixel value of each of the pixels A and B, which has output a detection signal, to a predetermined reference value. As the reference value, for example, a value indicating that the detection signal was recorded in all N subframes may be used. Alternatively, for example, if each of the effective values h and k is equal to or smaller than (N/2), the processing circuit 401 may use, as the reference value, a value indicating that the detection signal was recorded in (N/2) subframes, and if each of the effective values h and k exceeds (N/2), the processing circuit 401 may use, as the reference value, a value indicating that the detection signal was recorded in all N subframes. In this manner, the processing circuit 401 may change the reference value to be used in accordance with the number of subframes where light was detected. In that case, the threshold is not limited to the above-described two-stage threshold, and thresholds of three or more stages may be used.

Next, the weighting coefficient will be described. As described above, the weighting coefficient is generated based on the magnitude of the effective value of each of the plurality of pixels 104. The number of subframes where light was detected is smaller in the pixel A than in the pixel B. Therefore, the processing circuit 401 generates the weighting coefficient based on, for example, the ratio between the effective value (h) indicating the number of subframes where light was detected in the pixel A, and the effective value (k) indicating the number of subframes where light was detected in the pixel B. For example, the processing circuit 401 generates (h/k) as the weighting coefficient of the pixel A. After the weighting coefficient of the pixel A is generated, the processing circuit 401 processes the above-described reference value based on the weighting coefficient, thereby generating the pixel value of the pixel A. For example, the pixel value of the pixel A is generated by multiplying the reference value by (h/k). At this time, the pixel value of the pixel B remains the reference value, so that the pixel value of the pixel A becomes smaller than the pixel value of the pixel B. Accordingly, an image can be acquired with a pixel signal output distribution that closely matches the actual object.

The above description has focused on two pixels A and B, but more pixels 104 can be arranged in the pixel array 101. Therefore, the processing circuit 401 may generate the weighting coefficient of each pixel 104 based on the effective value of the target pixel 104 and the largest effective value of the pixel 104 among the plurality of pixels 104. Then, the processing circuit 401 can generate the pixel value of each pixel 104 by processing the reference value based on the weighting coefficient corresponding to each pixel 104.

Alternatively, for example, the plurality of pixels 104 arranged in the pixel array 101 may be divided into a plurality of groups each constituted by two or more pixels 104, and the weighting coefficient of each pixel 104 may be generated for each group. In this case, the processing circuit 401 may generate the weighting coefficient of each pixel 104 based on the effective value of the target pixel 104 and the largest effective value of the pixel 104 in the group including the target pixel 104. Then, the processing circuit 401 can generate the pixel value of each pixel 104 by processing the reference value based on the weighting coefficient corresponding to each pixel 104. Each group may be constituted by the pixels 104 arranged in each region obtained by dividing the pixel array 101 into regions of appropriate sizes. Alternatively, each group may be constituted by the pixels 104 arranged discretely in the pixel array 101.

The processing circuit 401 may set a predetermined threshold m for the effective value indicating the number of subframes where light was detected in this embodiment, and select the process. For example, for the pixel 104 whose effective value exceeds the threshold m among the plurality of pixels 104, the processing circuit 401 generates the pixel value by processing the reference value based on the weighting coefficient, as described above. In this case, for the pixel 104 whose effective value is equal to or smaller than the threshold, the processing circuit 401 may generate the pixel value based on the effective value (the number of subframes where light was detected). That is, when generating the pixel value of the pixel 104 whose effective value is equal to or smaller than the threshold, the processing circuit 401 may omit the process of applying the gain to the effective value to set the reference value and then applying the weighting coefficient to the reference value. For the pixel 104 in which the number of subframes where light was detected is equal to or smaller than the threshold, for example, the processing circuit 401 may generate the pixel value indicating that light was not detected. That is, the processing circuit 401 may truncate the effective value (signal value) of the pixel 104 in which the number of subframes where light was detected is equal to or smaller than the threshold.

In this embodiment, the example has been described in which, for each pixel 104, the number of subframes where light was detected (the detection signal was recorded) is used intact as the effective value to generate the weighting coefficient. However, the disclosure is not limited to this. For a given pixel 104, for example, the number of subframes where light was detected in the pixel 104 arranged around the given pixel 104 may be used as a condition for generating the weighting coefficient. For example, even if light was not detected in a given subframe in a given pixel 104, if light was detected in, for example, four or more pixels 104 among the pixels 104 adjacent to each other, the given pixel 104 may be corrected as light was detected. By executing various known arithmetic processing or selecting appropriate processing using artificial intelligence (AI) or the like, the accuracy of weighting can be further improved. For example, appropriate processing may be selected from past data in an environment approximated using AI. It is sufficient that appropriate weighting for each pixel 104 can be applied to the obtained image data (subframe).

As described above, the process according to the disclosure assumes image capturing under a dark environment. Therefore, the processing circuit 401 (photoelectric conversion device 100) may be configured to be operable in a plurality of driving modes including a driving mode for performing the above-described process based on the weighting coefficient, and operate by switching the driving mode in accordance with the image capturing condition. For example, as shown in FIG. 4, the photoelectric conversion device 100 may include the sensor 451 configured to detect the light amount. The sensor 451 supplies information of the detected light amount to the control circuit 402. If the light amount detected by the sensor 451 is equal to or smaller than a predetermined light amount, the control circuit 402 causes the processing circuit 401 to operate in the driving mode for performing the above-described process based on the weighting coefficient. If the light amount detected by the sensor 451 exceeds the predetermined light amount, the processing circuit 401 may generate a pixel value, for example, in accordance with the number of subframes where light was detected, without performing the above-described process based on the weighting coefficient. The determination as to whether the light amount exceeds the predetermined light amount may be performed by, for example, the sensor 451 or the control circuit 402.

Alternatively, for example, if the number of the pixels 104 that detected light in the plurality of subframes among the plurality of pixels 104 is equal to or smaller than a predetermined number, the processing circuit 401 may operate in the driving mode for performing the above-described process based on the weighting coefficient. For example, the number of the pixels 104 that detected light is acquired for each subframe, and if the number of the pixels 104 that detected light in a predetermined number of subframes, the predetermined number being one or more, is equal to or smaller than a predetermined number, the process based on the weighting coefficient may be performed. Alternatively, for example, if the total number of the pixels 104 that detected light in all subframes constituting one frame is equal to or smaller than a predetermined number, the process based on the weighting coefficient may be performed. In this case, the sensor 451 may or may not be arranged in the photoelectric conversion device 100.

In this manner, on a pixel basis, appropriate weighting is applied in accordance with the number of subframes where light was detected, and the pixel value is output. This enables acquisition of an image reproducing the actual object even in a dark environment without lowering the output frame rate. That is, even under an extremely dark environment where SPADs are expected to be used, such as a night vision scope, the accuracy of the acquired image can be improved.

In the above-described embodiment, the example has been described in which the weighting process is performed in accordance with the number of subframes where the detection signal indicating that the pixel 104 has detected light was recorded. However, the disclosure is not limited to this, and weighting may be applied in accordance with the frequency of subframes where light was detected. As described above, for each pixel 104 of the plurality of pixels 104, the processing circuit 401 acquires the effective value corresponding to the subframe where light was detected out of the plurality of subframes. At this time, the effective value may indicate the number of consecutive subframes where light was consecutively detected out of the plurality of subframes in the pixel 104.

For example, consider a case where, for N subframes constituting one frame, the pixel A detects light (the detection signal is recorded) in h consecutive subframes, the pixel B detects light (the detection signal is recorded) in k consecutive subframes, and k is larger than h (h < k). Here, each of h and k can be the maximum value of the number of consecutive subframes where light was detected in each of the pixels A and B. In this case, the processing circuit 401 first applies a gain to each of the effective values h and k of the pixels A and B, which indicates the number of consecutive subframes where light was consecutively detected, thereby setting a reference value. It can also be said that the processing circuit 401 sets the pixel value of each of the pixels A and B, which has output a detection signal, to a predetermined reference value. As the reference value, for example, a value indicating that the detection signal was recorded in all N subframes may be used. Alternatively, as described above, the processing circuit 401 may change the reference value to be set in accordance with the number of consecutive subframes where light was consecutively detected.

Next, the weighting coefficient will be described. As described above, the weighting coefficient is generated based on the magnitude of the effective value of each of the plurality of pixels 104. The number of consecutive subframes where light was consecutively detected is smaller in the pixel A than in the pixel B. Therefore, the processing circuit 401 generates the weighting coefficient based on, for example, the ratio between the effective value (h) indicating the number of consecutive subframes where light was consecutively detected in the pixel A, and the effective value (k) indicating the number of consecutive subframes where light was consecutively detected in the pixel B. For example, the processing circuit 401 generates (h/k) as the weighting coefficient of the pixel A. After the weighting coefficient of the pixel A is generated, the processing circuit 401 processes the above-described reference value based on the weighting coefficient, thereby generating the pixel value of the pixel A. For example, the pixel value of the pixel A is generated by multiplying the reference value by (h/k). At this time, the pixel value of the pixel B remains the reference value, so that the pixel value of the pixel A becomes smaller than the pixel value of the pixel B. When light is detected more consecutively, it is highly likely that an object that emits or reflects light exists in the corresponding portion. Accordingly, an image can be acquired with a pixel signal output distribution that closely matches the actual object.

The above description has focused on two pixels A and B, but more pixels 104 can be arranged in the pixel array 101. Therefore, as in the above description, the processing circuit 401 may generate the weighting coefficient of each pixel 104 based on the effective value of the target pixel 104 and the largest effective value of the pixel 104 among the plurality of pixels 104. Alternatively, as in the above description, the plurality of pixels 104 arranged in the pixel array 101 may be divided into a plurality of groups each constituted by two or more pixels 104, and the weighting coefficient of each pixel 104 may be generated for each group.

The processing circuit 401 may set the predetermined threshold m for the effective value indicating the number of consecutive subframes where light was consecutively detected in this embodiment, and select the process. For example, for the pixel 104 whose effective value exceeds the threshold m among the plurality of pixels 104, the processing circuit 401 generates the pixel value by processing the reference value based on the weighting coefficient, as described above. In this case, for the pixel 104 whose effective value is equal to or smaller than the threshold, the processing circuit 401 may generate the pixel value based on the effective value (the number of consecutive subframes where light was consecutively detected). That is, when generating the pixel value of the pixel 104 whose effective value is equal to or smaller than the threshold, the processing circuit 401 may omit the process of applying the gain to the effective value to set the reference value and then applying the weighting coefficient to the reference value. For the pixel 104 in which the number of subframes where light was detected is equal to or smaller than the threshold, for example, the processing circuit 401 may generate the pixel value indicating that light was not detected. That is, the processing circuit 401 may truncate the effective value (signal value) of the pixel 104 in which the number of subframes where light was detected is equal to or smaller than the threshold.

Furthermore, for example, if light was consecutively detected at the beginning of one frame period, more specifically, from the first subframe to a predetermined subframe (for example, the pth subframe) of the plurality of subframes, the processing circuit 401 may set, as the weighting coefficient, a coefficient indicating that the detection signal was recorded in all N subframes. In this case, in the (p+1)th and subsequent subframes of the pixel 104 where photons were detected p times consecutively, light detection may be stopped. This can reduce power consumption in the photoelectric conversion device 100.

In this embodiment, the example has been described in which, for each pixel 104, the number of subframes where light was consecutively detected (the detection signal was consecutively recorded) is used intact as the effective value to generate the weighting coefficient. However, the disclosure is not limited to this. For example, the number of times consecutive light detection was interrupted, the number of subframes where light was not detected, each present between the subframes where light was detected, or the like in each pixel 104 may be used as the condition for setting the weighting coefficient. For example, the number of consecutive light detections in the surrounding pixel 104 for each pixel 104 or the like may be used to set the weighting coefficient. By executing various known arithmetic processing or selecting appropriate processing using AI or the like, the accuracy of weighting can be further improved. For example, appropriate processing may be selected from past data in an environment approximated using AI. Furthermore, a complex process may be performed combined with the above-described weighting processing based on the number of subframes where light was detected. The disclosure is not limited to this, and it is sufficient that appropriate weighting for each pixel 104 can be applied to the obtained image data (subframe).

In this manner, on a pixel basis, appropriate weighting is applied in accordance with the frequency of subframes where light was detected, and the pixel value is output. This enables acquisition of an image reproducing the actual object even in a dark environment without lowering the output frame rate. That is, even under an extremely dark environment where SPADs are expected to be used, such as a night vision scope, the accuracy of the acquired image can be improved.

In each embodiment described above, the example has been described in which the photoelectric conversion device 100 includes the processing circuit 401. However, the disclosure is not limited to this. For example, the photoelectric conversion device 100 may include the output circuit 114 shown in FIG. 4, and the output circuit 114 may output the subframes to a processing device arranged outside, that can perform signal processing in a similar manner to the signal processing circuit 401. Thus, the above-described process based on the weighting coefficient can be executed.

An application example of the photoelectric conversion device 100 according to the embodiment described above will be described below. FIG. 5 is a schematic view of equipment EQP incorporating the photoelectric conversion device 100. As shown in FIG. 5, the photoelectric conversion device 100 is contained in a semiconductor package PKG. The semiconductor package PKG can include a base to which the photoelectric conversion device 100 is fixed, a lid such as glass facing the photoelectric conversion device 100, and a conductive connecting member such as a bonding wire or bump used to connect the terminal arranged in the base to a terminal arranged in the photoelectric conversion device 100. The equipment EQP may further include at least one of a control device CTRL, a processing device PRCS, a display device DSPL, and a storage device MMRY.

An optical system OPT is a system for forming an image on the pixel array 101, and can be, for example, a lens, a shutter, and a mirror. The control device CTRL is a device for controlling the operation of the photoelectric conversion device 100, and can be, for example, a semiconductor device such as an ASIC. The processing device PRCS processes the signal output from the photoelectric conversion device 100, and can be a semiconductor device such as a CPU or an ASIC. The display device DSPL can be an EL display device or a liquid crystal display device that displays data obtained by the photoelectric conversion device 100. The storage device MMRY is a magnetic device or a semiconductor device for storing data obtained by the photoelectric conversion device 100. The storage device MMRY can be a volatile memory such as an SRAM or a DRAM, or a nonvolatile memory such as a flash memory or a hard disk drive. A mechanical device MCHN can include a moving or propulsion unit such as a motor or an engine. For example, the mechanical device MCHN drives the components of the optical system OPT for zooming, focusing, and shutter operations. In the equipment EQP, data output from the photoelectric conversion device 100 is displayed on the display device DSPL, or transmitted to an external device by a communication device (not shown) included in the equipment EQP. Hence, the equipment EQP may include the storage device MMRY and the processing device PRCS.

The equipment EQP incorporating the photoelectric conversion device 100 is also applicable as a surveillance camera or an onboard camera mounted in transportation equipment such as an automobile, a railroad car, a ship, an airplane, or an industrial robot. In addition, the equipment EQP incorporating the photoelectric conversion device 100 is not limited to transportation equipment but is also applicable to equipment that widely uses object recognition, such as an intelligent transportation system (ITS).

According to the disclosure, a technique advantageous in improving image quality in a dark environment can be provided.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-018548, filed Feb. 6, 2025, which is hereby incorporated by reference herein in its entirety.

What is claimed is:

1. A conversion device comprising:
a plurality of pixels;
an output circuit configured to output subframes based on outputs of the plurality of pixels; and
a processing circuit configured to generate one frame from a plurality of subframes output from the output circuit,
wherein
for each pixel of the plurality of pixels, the processing circuit is configured to acquire an effective value corresponding to a subframe where light was detected out of the plurality of subframes, and is configured to generate a weighting coefficient of each pixel based on a magnitude of the effective value of each of the plurality of pixels, and
the processing circuit has a driving mode for generating a pixel value of each pixel in the frame based on the weighting coefficient.

2. The device according to claim 1, wherein
the effective value corresponds to a number of subframes where light was detected out of the plurality of subframes in each pixel.

3. The device according to claim 1, wherein
the effective value corresponds to a number of consecutive subframes where light was consecutively detected out of the plurality of subframes in each pixel.

4. The device according to claim 2, wherein
the processing circuit is configured to generate the weighting coefficient of each pixel based on the effective value of a target pixel and a largest effective value of a pixel among the plurality of pixels.

5. The device according to claim 2, wherein
the plurality of pixels are divided into a plurality of groups each constituted by not less than two pixels, and
the processing circuit is configured to generate the weighting coefficient of each pixel based on the effective value of a target pixel and a largest effective value of a pixel in a group including the target pixel.

6. The device according to claim 4, wherein
the processing circuit is configured to generate a pixel value of each pixel by processing a reference value based on the weighting coefficient.

7. The device according to claim 4, wherein
for a pixel whose effective value exceeds a threshold among the plurality of pixels, the processing circuit is configured to generate a pixel value by processing a reference value based on the weighting coefficient, and
for a pixel whose effective value is not more than the threshold among the plurality of pixels, the processing circuit is configured to generate a pixel value based on the effective value.

8. The device according to claim 4, wherein
for a pixel whose effective value exceeds a threshold among the plurality of pixels, the processing circuit is configured to generate a pixel value by processing a reference value based on the weighting coefficient, and
for a pixel whose effective value is not more than the threshold among the plurality of pixels, the processing circuit is configured to generate a pixel value indicating that light was not detected.

9. The device according to claim 2, wherein
in a case where light was consecutively detected from a first subframe to a predetermined subframe of the plurality of subframes, the processing circuit is configured to set, as the weighting coefficient, a coefficient indicating that light was detected in all subframes.

10. The device according to claim 1, further comprising a sensor configured to detect a light amount,
wherein
the driving mode is set as a first mode, and the processing circuit is configured to be operable in a plurality of driving modes including the first driving mode, and
in a case where a light amount detected by the sensor is not more than a predetermined light amount, the processing circuit is configured to operate in the first driving mode.

11. The device according to claim 1, wherein
the driving mode is set as a first driving mode, and the processing circuit is configured to be operable in a plurality of driving modes including the first driving mode, and
in a case where the number of pixels that detected light in the plurality of subframes among the plurality of pixels is not more than a predetermined number, the processing circuit is configured to operate in the first driving mode.

12. Equipment comprising:
the conversion device according to claim 1; and
a processing device configured to process a signal output from the conversion device.

13. A device that acquires a plurality of subframes output from an output circuit configured to output subframe based on outputs of a plurality of pixels, and generates one frame from the plurality of subframes, wherein
for each pixel of the plurality of pixels, the device is configured to acquire an effective value corresponding to a subframe where light was detected out of the plurality of subframes, and is configured to generate a weighting coefficient of each pixel based on a magnitude of the effective value of each of the plurality of pixels, and
the device has a driving mode for generating a pixel value of each pixel in the frame based on the weighting coefficient.

14. The device according to claim 13, wherein the effective value corresponds to a number of subframes where light was detected out of the plurality of subframes in each pixel.

15. The device according to claim 13, further comprising a processing circuit configured to generate the weighting coefficient of each pixel based on the effective value of a target pixel and a largest effective value of a pixel among the plurality of pixels.

16. The device according to claim 13, further comprising a processing circuit configured to generate the weighting coefficient of each pixel based on the effective value of a target pixel and a largest effective value of a pixel in a group including the target pixel,
wherein the plurality of pixels are divided into a plurality of groups each constituted by not less than two pixels.

17. The device according to claim 13, further comprising a processing circuit configured to set, as the weighting coefficient, a coefficient indicating that light was detected in all subframes, in a case where light was consecutively detected from a first subframe to a predetermined subframe of the plurality of subframes.

18. The processing device according to claim 13, wherein the effective value corresponds to a number of consecutive subframes where light was consecutively detected out of the plurality of subframes in each pixel.

19. The device according to claim 13, further comprising:
a sensor configured to detect a light amount; and
a processing circuit configured to be operable in a plurality of driving modes including a first driving mode,
wherein the driving mode is set as the first mode, and
wherein, in a case where a light amount detected by the sensor is not more than a predetermined light amount, the processing circuit is configured to operate in the first driving mode.

20. The device according to claim 13, further comprising a processing circuit configured to be operable in a plurality of driving modes including a first driving mode,
wherein the driving mode is set as the first driving mode, and
wherein, in a case where the number of pixels that detected light in the plurality of subframes among the plurality of pixels is not more than a predetermined number, the processing circuit is configured to operate in the first driving mode.
